(19) United States
(12) Patent Application Publication
(10) Pub. No.: US 2008/0152574 A1
(43) Pub. Date: Jun. 26, 2008

(54) Oil Agent for Precursor Fiber of Carbon Fiber, Carbon Fiber and Production Method of the Carbon Fiber

(75) Inventors: Fumihiko Tanaka, Ehime (JP); Yasumasa Yamamoto, Tokyo (JP)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Toray Industries, Inc, A Corporation of Japan, Tokyo (JP)

(21) Appl. No.: 11/793,163

(22) PCT Filed: Dec. 26, 2005
(86) PCT No.: PCT/JP2005/023702

§ 371 Date: Jun. 14, 2007

(30) Foreign Application Priority Data
Dec. 27, 2004 (JP) JP 2004-375777
Feb. 8, 2005 (JP) JP 2005-042471
Jun. 30, 2005 (JP) JP 2005-191348

(51) Int. Cl. D01F 9/12; D01F 11/06; D01F 9/22; D01D 10/00; C08G 77/14; D01D 5/06; D01F 6/18

(52) U.S. Cl. 423/447.2; 264/29.2; 528/10

(57) ABSTRACT

By using an oil agent for precursor fiber of carbon fiber containing a base compound and a liquid fine particle, and said liquid fine particle contains a liquid of which kinematic viscosity at 150° C. is 15000 cSt or more, it is possible to suppress an uneven stabilization in stabilizing process, and it becomes possible to provide a carbon fiber of high performance and uniform quality.

### TECHNICAL FIELD

The present invention relates to a carbon fiber having a narrow single filament modulus distribution, a production method of carbon fiber capable of producing said carbon fiber in a high operation efficiency and an oil agent for precursor fiber of carbon fiber used in said production method.

### BACKGROUND ART

Because carbon fiber has a higher specific strength and specific modulus than other fibers, as reinforcing fiber for composite materials, in addition to conventional sports and aerospace applications, it is being widely developed in general industrial applications such as for car, civil engineering, construction, pressure container and windmill blade. In particular, in sports or aerospace applications, improving carbon fiber into still higher strength and higher modulus are strongly demanded. Furthermore, as well as these improvements for performance enhancement, improvements in material tolerances, which should be achieved by increasing the reliability of carbon fiber, is demanded.

Polyacrylonitrile-based carbon fiber which is most widely used among carbon fibers is industrially produced by carrying out, in this order, a spinning process in which a polyacrylonitrile-based polymer to be a precursor is subjected to a wet spinning or semi-wet spinning to obtain a precursor fiber of carbon fiber (hereafter, abbreviated as precursor fiber), a stabilizing process in which said precursor fiber is heated under an oxidizing atmosphere of a temperature of 200 to 400° C. to convert it into a stabilized fiber and a carbonizing process in which said stabilized fiber is heated to be carbonized under an inert atmosphere of a temperature of at least 1000° C. to convert it into a carbon fiber.

In order to obtain a high performance carbon fiber, in the above-mentioned respective production processes, it is tried to set to a high tension or to a high draw ratio. However, at that time, since single fiber may fusion-bond with each other to impair appearance and quality, there is a problem that, in order to produce stably, it is unavoidable to produce at a compromised draw ratio.

To this problem, many techniques for imparting silicone oil agent of high heat resistance to polyacrylonitrile-based precursor fiber are proposed and industrially and widely applied. For example, it is disclosed that an oil agent in which specific amino-modified silicone, epoxy-modified silicone, or alkylene oxide-modified silicone is mixed is small in weight loss when heated in air or in nitrogen and highly effective in preventing fusion-bonding (for example, patent reference 1). However, the silicone oil agent used here intervenes between single fibers in the stabilizing process and prevents oxygen supply which is essential for stabilization reaction, and as a result, induces an arising uneven progression of stabilization reaction (so-called uneven stabilization). Furthermore, for this reason, there is a problem that a fiber breakage or fuzz generation may arise in successive carbonization process to cause an impairment against improvement of productivity. To this problem, a technique of improvement by specifying curing behavior of silicone oil agent (for example, patent reference 2) is disclosed, but a further improvement of performance of carbon fiber has its own limit.

patent reference 1: JP-Hei 3-40152A (entire document)
patent reference 2: JP-2001-172880A (entire document)

### DISCLOSURE OF THE INVENTION

### Problem to be Solved by the Invention

The present invention solves the above-mentioned problem and provides an oil agent for precursor fiber of carbon fiber to produce a carbon fiber having a high quality and in addition uniform quality and a production method of carbon fiber using it, and a carbon fiber having a high quality and in addition uniform quality.

### Means for Solving the Problem

The inventors of the present invention paid attention to the role of oil agent, and as a result of an intensive investigation, found the method mentioned below.

That is, the present invention is an oil agent for carbon fiber precursor containing a base compound and a liquid fine particle, and said liquid fine particle contains a liquid of which kinematic viscosity at 150° C. is 15000 cSt or more.

Furthermore, the present invention is an oil agent for precursor fiber of carbon fiber containing a base compound and a thermosensitive polymer.

Furthermore, the present invention is an oil agent for precursor fiber of carbon fiber containing a silicone compound of which average kinematic viscosity at 25° C. is 10 to 1500 cSt, and a difference of osicillation period of pendulum of said silicone compound between 30° C. and 180° C. measured by the free damped oscillation method of rigid-body pendulum is 0.03 to 0.4 seconds. Furthermore, the present invention is a production method of carbon fiber containing at least a spinning process in which a polyacrylonitrile-based polymer is spun to obtain a precursor fiber of carbon fiber, stabilizing process in which said precursor fiber is heated under oxygen containing gas atmosphere at a temperature of 200 to 400° C. to be converted to a stabilized fiber, and a carbonization process in which said stabilized fiber is heated under an inert atmosphere at a temperature of at least 1000° C. to be carbonized and converted to a carbon fiber, wherein in the above-mentioned spinning process, an oil agent for precursor fiber of carbon fiber which satisfies at least one condition of the above-mentioned conditions is imparted to said precursor fiber.

Furthermore, the present invention is a carbon fiber of which coefficient of variance of single filament modulus determined by single fiber tensile test is 10% or less.

### EFFECT OF THE INVENTION

The oil agent for precursor of carbon fiber of the present invention (hereafter, abbreviated as the oil agent), by containing, other than the base compound, a liquid fine particle containing a liquid of which kinematic viscosity at 150° C. is 15000 cSt or more as an essential component, not only prevents fusion-bonding between single fibers in the spinning process of the precursor fiber of carbon fiber (hereafter, abbreviated as the precursor fiber), but also makes it possible to prevent adhesion between single fibers with each other without damaging the precursor fiber in the following stabilizing process.

Furthermore, in other embodiment of the oil agent of the present invention, the effect of the oil agent becomes uniform in the entire fiber bundle by presence of the thermosensitive polymer other than the base compound.

Furthermore, in other embodiment of the oil agent of the present invention, by maintaining curability while lowering the average kinematic viscosity at 25° C., it becomes possible to form an oil agent film, of which surface is smooth and in addition not deformable, on the precursor fiber.

Accordingly, by imparting an oil agent which satisfies at least one condition of the above-mentioned conditions in the spinning process of the precursor fiber, oxygen is uniformly fed to each single fiber of the precursor fiber bundle in the following stabilizing process and an uneven stabilization can be avoided. As a result, even in case of a higher yarn density, a higher tension, a higher speed carbonization condition than conventional case, it is possible to produce a carbon fiber having a stable quality without a fuzz or fiber breakage, and accordingly, it is possible to obtain a high quality and uniform quality carbon fiber having a narrow single filament modulus distribution. By using such a carbon fiber, it is possible to mold a composite material with a high performance and high reliability.

### BEST EMBODIMENT FOR CARRYING OUT THE INVENTION

One embodiment of the oil agent of the present invention is an oil agent containing a base compound and a liquid fine particle, and said liquid fine particle contains, as an essential component, a liquid of which kinematic viscosity at 150° C. is 15000 cSt or more.

By applying the above-mentioned liquid fine particle to the precursor fiber, it is possible to prevent an uneven stabilization in the stabilizing process. The reason is not necessarily clear, but is considered as follows. That is, the uneven stabilization in the stabilizing process is caused by a prevention of oxygen permeation into fiber bundle to produce a portion where oxygen is not sufficiently supplied. It is understood as the oxygen permeation preventing factor that single fibers in the precursor fiber yarn fusion-bonded with each other or that the oil agent used to prevent fusion-bonding binds single fibers on the contrary. In case of the latter, that is, the oil agent penetrates between the single fibers and functions like an adhesive to bind the single fibers. When considered the oxygen permeation into fiber bundle, if fusion-bonded single fibers is present or a cured oil agent between single fibers is present, oxygen must diffuse through them and the amount of oxygen permeation decrease compared to the oxygen permeation through a space where single fibers are not bound, i.e., oxygen is not supplied uniformly to cause an uneven stabilization. In general, the oil agent is imparted just before drying process in the spinning process, and subjected to a heat drying treatment. At the time of this heat drying treatment, if one drop of the oil agent is present between the single fibers, and if it extends to neighboring single fibers and is cured as it is, the oil agent may function like an adhesive, and as a result, it is considered that an uneven stabilization is produced. And, if a drop of the oil agent present on a single fiber is united with a drop on a neighboring single fiber before curing, it may also be considered to function in the same way like an adhesive. On the other hand, in this embodiment, by the presence of the specific liquid fine particle, during the spinning process, the liquid fine particle of the high kinematic viscosity functions as a spacer and keeps a clearance between the single fibers to thereby prevent adhesion of the single fibers with each other. Furthermore, it is understood that a uniform stabilization becomes possible since oxygen supply route is maintained to supply oxygen uniformly within the fiber bundle in the stabilizing process. Although a similar effect can be expected by using a solid fine particle as a spacer, there may be a disadvantage that the solid fine particle damages the precursor fiber or a solid fine particle fallen off from the single fibers stains the production process. However, the liquid fine particle of this embodiment is a liquid, different from a solid, and does not damage the precursor fiber by deforming itself, in addition, there is an advantage that falling off in the production process such as to rollers is small. However, when the viscosity of the liquid fine particle is too low, the liquid fine particle deforms in the spinning process, and the clearance between the single fibers decreases. For that reason, as the liquid contained in the liquid fine particle, the higher the kinematic viscosity, the more preferable it is, and therefore, a liquid of which kinematic viscosity at 150° C., which is near the temperature of the drying process in fiber production, is 15000 cSt or more, preferably 80000 cSt or more, more preferably 150000 cSt or more is used. Upper limit of the kinematic viscosity is not especially limited. If the kinematic viscosity is too high, since making fine particle may become difficult, in order to make into a fine particle, the kinematic viscosity is preferably 15000000 cSt or less, but when it is possible to make into a fine particle by an emulsion polymerization or the like, a higher viscosity than that is allowed. However, in order to exhibit characteristics as a liquid fine particle, it is preferable that the liquid can deform at 150° C. Where, to be able to deform at 150° C. means that the shape is changed when a liquid is deposited on a hot plate maintained at 150° C. and said hot plate is left vertically and observed after 1 hour. Here, when a liquid in the oil agent is to be measured, the measurement may be carried out after the liquid is separated by centrifugation or the like as mentioned below.

The kinematic viscosity of the liquid can be determined by the following method. 10 ml liquid maintained at a predetermined temperature is set to an Ostwald type viscometer (capillary viscometer), and the time t (sec) in which the upper surface of the liquid to be measured passed through a predetermined distance is measured. When the viscosity of standard liquid is put to η₀ (cP), the density is put to ρ₀ (g/cm³) and the flow down time is put t₀ (sec), the kinematic viscosity is calculated by the following equation.

kinematic viscosity (cSt)=(η₀/ρ₀)×(t/t₀)

Where, regarding the measurement of kinematic viscosity of the liquid in the oil agent, the liquid fine particle is separated by centrifugation and an emulsifier is separated from the separated liquid fine particle by pH adjustment, and the kinematic viscosity is measured after extracting the liquid.

As the liquid used in this embodiment, it is not especially limited as far as the above-mentioned range is satisfied, oils such as a mineral oil or a synthetic oil, and a silicone oil are preferably used. Among them, silicone oil is especially preferably used since its viscosity temperature coefficient is small or its releasability is high.

As the silicone oil, basically those having a linear siloxane skeleton are preferable. It may have some branched chains or cross-linkings, but those having a linear structure as a whole are preferable. As organic group which bonds to silicon atom in the molecule, alkyl group such as methyl, ethyl, propyl, butyl and hexyl; cycloalkyl group such as cyclohexyl; alkenyl group such as vinyl and allyl; aryl group such as phenyl, tolyl, glycidyl group, alicyclic epoxy group, amino group, or the like are exemplified. If such an organic group is reactive, a cross-linking reaction may start before the stabilizing process to make the liquid fine particle into a solid spacer or the like, and therefore, said organic group is preferably non-reactive. As said organic group, in particular, methyl group or alicyclic epoxy group is preferable, and methyl group is most preferable. In case where a reactive group is contained in a portion of said organic group, in view of preventing a gelation, an equivalent of said reactive group is preferably 40.00 g/mol or more, 10000 g/mol or more is more preferable and 50000 g/mol or more is still more preferable. As other group which bonds to the silicon atom, alkoxy group, hydroxyl group, hydrogen atom or the like may partially be contained. Where, as terminal group of the molecular chain, triorganosilyl group, or the group of which organic group is partly substituted with hydroxyl group is exemplified. In particular, trimethyl silyl group of which reactivity is low is preferable. Such a silicone oil may be used alone, or as a mixture of two or more kinds.

In case of a silicone oil, the kinematic viscosity at 150° C. can also be determined by a calculation provided T=150° C. in the following equation, using the kinematic viscosity at 25° C. However, in case where this calculated value and the above-mentioned measured value are different, the measured value is used.

log η^{T}={763.1/(273+T)}−2.559+log η²⁵

T: 150(° C.), log η^{T}: kinematic viscosity (cSt) at T° C., log η²⁵: kinematic viscosity (cSt) at 25° C.

As the production method of the liquid fine particle used for the oil agent of this embodiment, for example, a method of emulsifying a liquid of a high kinematic viscosity such as the above-mentioned silicone oil using a dispersion medium or a method for obtaining a silicone oil by an emulsion polymerization or the like are mentioned. As the dispersion medium, it may be an organic solvent, but in view of imparting uniformity and imparting convenience to the precursor fiber, it is preferable to use water.

When water is used as the dispersion medium, it is preferable to use a surfactant together. As the surfactant, its kind is not especially limited, and any surfactant of anionic, cationic, nonionic and zwitterionic types can be used. Combinations of these can be used except combinations of anionic surfactant and cationic surfactant. Among them, a cationic surfactant is preferable, a weak cationic surfactant containing an amino group or the like is more preferable and a nonionic surfactant is especially preferably used. As nonionic type surfactants, for example, an alkyl ether, alkyl phenyl ether or alkyl amine ether of polyethylene glycol, or the like can be mentioned. As the hydrodynamical particle diameter of the liquid fine particle when it is emulsified or dispersed, 0.05 to 5 μm is preferable, 0.1 to 1 μm is more preferable, 0.2 to 0.7 μm is still more preferable. If the hydrodynamical particle diameter of the liquid fine particle is too small, emulsification or dispersion may become difficult notwithstanding its effect may saturate. If the hydrodynamical particle diameter of the liquid fine particle is too large, the fine particle does not reach around the center of fiber bundle, and may cause an uneven deposition. Such a hydrodynamical particle diameter can be determined by Cumulant method using a particle size distribution measuring instrument which is based on a theory of such as light scattering. In case where a surfactant is used, as to the amount of its addition, in view of emulsifying ability or storage stability, 5 to 30 parts by weight to 100 parts by weight of the high kinematic viscosity liquid contained in the above-mentioned liquid fine particle is preferable and 10 to 20 parts by weight is more preferable. Where, it is a preferable method to use plural kinds of surfactant for stability of emulsion or dispersion.

Furthermore, the liquid fine particle of this embodiment, has an effect of preventing fusion-bonding between single fibers, but on the other hand, due to curing of the liquid fine particle, effect of unifying the single fibers with each other decreases. Accordingly, it is preferable that the liquid fine particle cures as little as possible during the spinning process. In view of this point, it is preferable that the liquid fine particle has a difference of osicillation period of pendulum between 30° C. and 200° C. measured by the free damped oscillation method of rigid-body pendulum is 0.1 seconds or less. The difference of osicillation period is more preferably 0.05 seconds or less, still more preferably 0.03 seconds or less. The free damped oscillation method of rigid-body pendulum is explained in detail later. According to the free damped oscillation method of rigid-body pendulum, being different from ordinary rheometer, it is possible to measure a viscoelastic behavior in an open system, and in a condition of a thin film. The osicillation period measured by such a measuring method corresponds to the degree of cross-linking of the liquid fine particle, and it is indicated that the smaller the osicillation period, the higher the degree of cross-linking. Accordingly, the difference of osicillation period of pendulum between 30° C. and 200° C. corresponds to the curing behavior when heated, and it is indicated that the larger the difference of osicillation period, the easier to be cured by heating, i.e., easy to be cross-linked. On the contrary, it is indicated that the smaller the difference of osicillation period of pendulum between 30° C. and 200° C., the more difficult to be cured by heating, i.e., difficult to be cross-linked. Since it is preferable that the degree of curing of the liquid fine particle when heated is as low as possible, it is preferable that the difference of osicillation period of pendulum between 30° C. and 200° C. is as small as possible. By using the liquid fine particle of which difference of osicillation period of pendulum between 30° C. and 200° C. is in the above-mentioned range, it is possible to suppress the degree of curing of the liquid fine particle during spinning process and therefore, it becomes unlikely that the liquid fine particle functions as an adhesive between single fibers. Furthermore, in order that this liquid fine particle does not induce adhesion between the single fibers in the successive stabilizing process, it is appropriate to use a liquid fine particle of which difference of osicillation period of pendulum between 30° C. and 300° C. is preferably 0.1 second or less, more preferably 0.05 seconds or less.

The base compound referred to in the present invention denotes a component of which amount in weight is the largest in the oil agent except the liquid fine particle, the thermosensitive polymer and the liquid medium. However, as mentioned later, for example, in case where a plural of silicone compounds are used by mixing as a base compound, the entire mixture of the plural of the silicone compounds is defined as the base compound. The base compound is not especially limited as far as it has a preventing effect of fusion-bonding, or a single fiber bundle formation effect, but as explained in the background art, a silicone compound can be preferably used since it generally has an excellent preventing effect of fusion-bonding. A silicone compound can also be used as the above-mentioned liquid fine particle, but as such a silicone compound, those with a high kinematic viscosity are selected in order to exhibit the spacer effect, and they are unlikely to perfectly coat the fiber, and the preventing effect of fusion-bonding is insufficient. Accordingly, the liquid fine particle is not included in the base compound. As the silicone compound used as the base compound, those with a low kinematic viscosity are preferable since they form a uniform film by its excellent extensibility, to prevent fusion-bonding between single fibers. As such a silicone compound, in order to quickly form a smooth and uniform surface film, those with the kinematic viscosity at 25° C. is preferably 10 to 10000 cSt, more preferably 100 to 2000 cSt, still more preferably 300 to 1000 cSt are used.

As the silicone compound, for example, diorganopolysiloxanes such as dimethyl polysiloxane, or various kinds of modified products based thereon such as amino-modified silicone, an alicyclic epoxy-modified silicone and an alkylene oxide-modified silicone (also referred to as polyether-modified silicone) or the like are known and can be used in the present invention. The amino-modified silicone has a high affinity to fibers. The alkylene oxide-modified silicone is excellent in emulsion stability. The alicyclic epoxy-modified silicone is excellent in heat resistance. It is preferable that the base compound contains at least the amino-modified silicone; it is more preferable to contain the amino-modified silicone and the alkylene oxide-modified silicone together; it is especially preferable to contain the amino-modified silicone, the alicyclic epoxy-modified silicone and the alkylene oxide-modified silicone all together. The amount of the amino-modified silicone is preferably 20 to 100 wt % in the base compound and more preferably 30 to 90 wt % and still more preferably 40 to 80 wt %.

Furthermore, it is no problem if the base compound of the oil agent of the present invention is soluble in a liquid medium or self-emulsifiable, but if it is not soluble or self-emulsifiable, it is preferable to use together with a surfactant such as emulsifier or dispersant to emulsify or disperse. Regarding the surfactant used in the oil agent of the present invention, its kind is not especially limited, and any surfactant of anionic, cationic, nonionic type and zwitterionic type can be used. Combinations of these can be used except combinations of anionic surfactant and cationic surfactant. Among them, a cationic surfactant is preferable and a weak cationic surfactant containing an amino group or the like is more preferable and a nonionic surfactant is especially preferably used. As the nonionic type surfactants, for example, an alkyl ether, an alkyl phenyl ether or an alkyl amine ether of polyethylene glycol or the like can be mentioned. As the hydrodynamical particle diameter of the emulsified or dispersed base compound, 0.001 to 1 μm is preferable, 0.01 to 0.5 μm is more preferable and 0.05 to 0.2 μm is especially preferable. If the hydrodynamical particle diameter of the base compound is smaller than 0.001 μm, emulsification or dispersion may become difficult notwithstanding its effect apt to saturate. If the hydrodynamical particle diameter of the base compound is larger than 0.5 μm, the fine particle does not reach around the center of fiber bundle, and may cause an uneven deposition. Such a hydrodynamical particle diameter can be determined by Cumulant method using a particle size distribution measuring instrument based on a theory of such as light scattering. The amount of addition of the surfactant to the base compound depends on the combination of surfactant, base compound and the liquid medium and it cannot be discussed in one standard. However, it is preferable to select such a kind of surfactant which would achieve the above-mentioned average particle diameter, and which would become 0 to 60 parts by weight to the base compound 100 parts by weight, preferably 0 to 35 parts by weight. Where, it is a preferable method to use plural kinds of surfactant for stability of emulsion or dispersion.

The concentration of the base compound cannot be discussed easily since it is closely related to how much the oil agent is imparted to the fiber bundle, and the effect of the base compound depends on its kind, but it is preferable to be about 0.1 to 10 wt % to the total amount of the oil agent. What is more important is that, as mentioned above, the viscosity of the oil agent preferably does not exceed 50 cP.

The weight ratio of the above-mentioned liquid fine particle and the base compound varies according to the kind of base compound and it cannot be discussed easily, but the liquid fine particle 0.1 to 50 parts by weight to the base compound 100 parts by weight is preferable, 1 to 50 parts by weight is more preferable, 5 to 15 parts by weight is still more preferable.

Another embodiment of the oil agent of the present invention is that which contains the base compound and the thermosensitive polymer.

The thermosensitive polymer referred to in this embodiment denotes a polymer, in a mixed liquid of the polymer and a liquid medium, having a property substantially soluble at a temperature lower than a specified temperature, and at least a portion of said polymer is precipitated from the liquid medium at a temperature higher than the specified temperature. Said specific temperature is called as cloud point or lower critical solution temperature.

As the thermosensitive polymer, for example, a molecule consisting of ethylene oxide chain and a hydrophobic portion, for example, an alkyl group or an alkylene oxide chain with 3 or more carbon atoms, having a weight average molecular weight 2,000 or more, more preferably, a molecule having a weight average molecular weight 5,000 or more, still more preferably, a molecule having a weight average molecular weight 10,000 or more, or a homopolymer of N-alkyl (meth)acrylamide or a copolymer of the above-mentioned monomer with (meth) acrylic acid or the like, a copolymer of dimethyl amino ethyl (meth)acrylate with a multi-functional monomer such as ethylene glycol dimethacrylate or the like, etc., or a mixture thereof, or the like are mentioned. Among them, a polymer containing any or both of N-isopropyl acrylamide or dimethyl amino ethyl methacrylate as monomer component is preferably used. In case of N-isopropyl acrylamide, the lower critical solution temperature of its homopolymer is about 32° C. in water, but the cloud point or the lower critical solution temperature can be controlled by copolymerization. Basically, when a hydrophilic monomer such as anionic monomer, cationic monomer, nonionic type or the like is copolymerized, the lower critical solution temperature raises. As the anionic monomers, for example, (meth) acrylic acid or a monomer having a sulfonic acid group, more concretely, styrene sulfonic acid or the like are mentioned. As the cationic monomers, nitrogen-containing monomers, for example N,N-dimethyl acrylamide, N,N-dimethyl amino propyl acrylamide, N,N-diethyl acrylamide or the like are mentioned. As the nonionic type hydrophilic monomers, for example, a vinyl-based compound or (meth)acrylate having a hydrophilic group, more concretely, N-vinyl-2-pyrrolidone, hydroxyalkyl (meth)acrylate or the like, still more concretely, 2-hydroxyethyl (meth)acrylate or the like are mentioned. Not limited thereto, various monomers can be used.

Where, for example, in case where an ionic substance is contained in the oil agent, in order to prevent an inconvenience on its function or condition as an oil agent by coagulation or the like, it is preferable that the thermosensitive polymer is at least not of the ionic property opposite to said ionic substance. More concretely, in case where the emulsifier is cationic, or the base compound contains an amino group, it is preferable that the thermosensitive polymer is a cationic or nonionic type.

As the liquid medium, a hydrophilic medium is preferable in order that the cloud point or the lower critical solution temperature of the thermosensitive polymer would appear, especially water is preferable.

Conventional oil agents consist of a base compound and a liquid medium, but by using the thermosensitive polymer together, the adhesion preventing effect or the fusion-bonding preventing effect between the single fibers with each other in the bundle of the precursor fiber of carbon fiber becomes still more effective. Its mechanism is not necessarily clear, but is considered as follows. That is, in the spinning process, after the oil agent consisting of the base compound and the liquid medium is imparted to the precursor fiber bundle, it is subjected to a heat dry treatment. At that time, since the liquid medium vaporizes to the atmosphere from the surface of precursor fiber bundle, the liquid medium in the fiber bundle moves toward the surface of fiber bundle. Accompanied to this, since the base compound solved, emulsified or dispersed in the liquid medium also moves, the base compound becomes insufficient in the fiber bundle, to decrease the effect of the oil agent. However, in case where the thermosensitive polymer is present, when the oil agent is heated and its temperature exceeds the cloud point or the lower critical solution temperature of the thermosensitive polymer, the thermosensitive polymer precipitates and the entire oil agent is changed to a gelled state. It is considered that, for this reason, the movement of the base compound at the time of vaporization of the liquid medium is prevented, the insufficiency of the base compound inside the fiber bundle is solved, and the effect of the oil agent becomes uniform in the entire fiber bundle. Furthermore, there is a possibility that the oil agent present between the single fibers is extruded by the movement of the single fibers during the heating, to fusion-bond or adhere the single fibers with each other, but it is considered that, by the effect of the thermosensitive polymer, the oil agent becomes unlikely to be extruded by the gelation, and the fusion-bonding or adhesion of the single fibers with each other is prevented. Such an effect is exhibited because the thermosensitive polymer has the cloud point or the lower critical solution temperature, and there is no effect when a polymer with no thermosensitibity is used. For example, in case where the liquid medium is water, even if an ordinary water-soluble polymer such as polyvinyl alcohol or various kinds of water-soluble gum is used, they are concentrated in where the water vaporizes, i.e., on surface of the fiber bundle, and since they precipitate for the first time when they exceeds their saturated solubility, they cannot prevent the movement of the base compound from inside the fiber bundle to the surface, and they have no preventing effect for the extrusion of the oil agent from between the single fibers.

From the above-mentioned estimated mechanism, it is preferable that the cloud point or the lower critical solution temperature of the thermosensitive polymer is higher than the oil agent temperature when it is imparted to the bundle of the precursor fiber of carbon fiber and lower than the boiling point of the liquid medium. Concretely, as the cloud point or the lower critical solution temperature, 20 to 98° C. is preferable, 30 to 80° C. is more preferable and 35 to 70° C. is still more preferable. Even if the cloud point or the lower critical solution temperature is 20° C. or lower, it is not especially a problem if the oil agent can be imparted to the fiber bundle at a temperature lower than that, but when an ordinary room temperature or a room temperature in summer is taken into consideration, since it is necessary to cool the oil agent or to cool the production environment, it cannot be said to be a preferable choice in view of production cost, operation efficiency, etc. On the other hand, in case where the cloud point or the lower critical solution temperature exceeds 98° C., it is not preferable since the difference of temperature between the room temperature and the cloud point or the lower critical solution temperature is big, and when heated, notwithstanding that the inside of the fiber bundle does not reach the cloud point or the lower critical solution temperature, the fiber bundle surface reaches the boiling point of the liquid medium, to increase a possibility of starting movement of the liquid medium, base compound or thermosensitive polymer from the inside of the fiber bundle toward the surface. Accordingly, it can be said that using a thermosensitive polymer of which cloud point or the lower critical solution temperature is made as low temperature as possible in the temperature range higher than the highest oil agent temperature in year at production place is practical, and can brings about the maximum effect.

Regarding concentration of the thermosensitive polymer cannot be discussed easily since an appropriate value varies according to combination of kinds of the thermosensitive polymer and the liquid medium, but about 0.0001 to 10 wt % to the total amount of the oil agent is preferable. What is more important is that the viscosity of the oil agent at the temperature when the oil agent is imparted to the bundle of the precursor fiber of carbon fiber is preferably 1 to 50 cP, more preferably 1 to 20 cP, especially preferably 2 to 10 cP. When the viscosity exceeds 50 cP, it becomes difficult to uniformly impart the oil agent in the fiber bundle. The lower limit of the viscosity is not especially limited, and it is appropriate to be as low as possible in view of uniform deposition. However, for example, when water of which viscosity is about 1 cP is chosen as the liquid medium, the viscosity of the oil agent may be 2 cP or more when the thermosensitive polymer and the base compound are added. Where, the viscosity of the oil agent can be measured by using a commercialized rotation viscometer. At that time, the measurement temperature is set to the temperature of the oil agent when the oil agent is imparted to the precursor fiber bundle. In case where the oil agent has a property such as thixotropy or the like in which viscosity varies according to shearing stress, asymptotic viscosity when the shearing stress is varied is considered as the viscosity referred to in the present invention. When the asymptotic viscosity is difficult to be expected by characteristics of the rotation viscometer, twice of the viscosity when maximum shearing stress is loaded to the rotation viscometer is considered as the viscosity of the present invention. As rotation viscometer capable of being used, R type viscometer produced by Toki Sangyo Co. (model name: RE115L) is mentioned as an example.

The mixing ratio of the thermosensitive polymer and the base compound cannot be discussed easily since it varies according to their kinds, but to the base compound 100 parts by weight, thermosensitive polymer 0.001 to 50 parts by weight is preferable, 0.01 to 20 parts by weight is more preferable and 0.1 to 10 parts by weight is especially preferable.

Furthermore, it is preferable to use the above-mentioned liquid fine particle in combination, in addition to the thermosensitive polymer and the base compound, as the oil agent, since it exhibits a synergistic effect as mentioned below. That is, by the effect of thermosensitive polymer, the movement of the oil agent from inside of the fiber bundle to the surface during the heat dry treatment is prevented and the extrusion of the oil agent from between the single fibers is prevented. Furthermore, by the effect of the liquid fine particle, clearances are made between the single fibers, and a preventing effect of unifying the cured films formed with the thermosensitive polymer and the base compound with each other is exhibited.

The weight ratio of the liquid fine particle, the thermosensitive polymer and the base compound varies according to kind or the like of the base compounds and it cannot be discussed easily, but about 0.1 to 50/0.001 to 50/50 to 99.899 is preferable, 1 to 50/0.01 to 20/50 to 98.99 is more preferable and 5 to 15/0.1 to 10/75 to 94.9 is still more preferable.

Furthermore, another embodiment of the oil agent of the present invention contains a silicone compound of which average kinematic viscosity at 25° C. is 10 to 1500 cSt, and the difference of osicillation period of pendulum between 30° C. and 180° C. of said silicone compound measured by the free damped oscillation method of rigid-body pendulum is 0.03 to 0.4 seconds.

Here, the average kinematic viscosity is the value in which the kinematic viscosities of the respective silicone compounds contained in the oil agent is averaged by weight according to the mixing ratio. However, the silicone compound contained in the liquid fine particle is removed. That is, it is the weight average value of the kinematic viscosities of the silicone compounds contained in the oil agent as the base compound. If the silicone compound contained in the oil agent is one kind, its kinematic viscosity is the average kinematic viscosity. The kinematic viscosity is measured by using Ostwald type viscometer at 25° C.

The silicone compound of this embodiment has an average kinematic viscosity at 25° C. of 10 to 1500 cSt. As the average kinematic viscosity, 50 to 1000 cSt is preferable and 100 to 500 cSt is more preferable.

In conventional oil agents, in view of heat resistance, a silicone compound of a high kinematic viscosity has been apt to be used, but the silicone compound of this embodiment is a silicone compound of lower kinematic viscosity than conventional one. By using such a low kinematic viscosity silicone compound as the base compound, it is possible to prevent an uneven stabilization in the stabilizing process. In case where the kinematic viscosity of the silicone compound exceeds 1500 cSt, the effect of preventing uneven stabilization becomes insufficient. On the other hand, in case where the kinematic viscosity of the silicone compound is less than 10 cSt, the viscosity of the oil agent is insufficient, and when the oil agent is squeezed out by a nip or the like in spinning process, the oil agent is unlikely to be maintained between the single fibers, and a sufficient preventing effect of fusion-bonding between the single fibers in drying process or the like cannot be obtained.

And, the difference of osicillation period of pendulum T between 30° C. and 180° C. by the free damped oscillation method of rigid-body pendulum mentioned here, is the difference between the osicillation period (sec) at 30° C. measured by the free damped oscillation method of rigid-body pendulum mentioned later for the silicone compound contained in the oil agent as the base compound, and the osicillation period (sec) measured in the same way for said silicone compound after a heat treatment at 180° C. for 20 minutes. That is, what the difference of osicillation period T is 0.03 to 0.4 seconds is expressed in the following equation.

0.03≦T≦0.4

T=T30−T180

T30: osicillation period (sec) at 30° C.

T180: osicillation period (sec) after heat treatment at 180° C. for 20 minutes

In the low kinematic viscosity silicone compound of this embodiment, the difference of osicillation period T is 0.03 to 0.4 seconds, 0.05 to 0.35 seconds is preferable and 0.10 to 0.30 seconds is more preferable. By using a silicone compound having such a difference of osicillation period T, it is possible to prevent an uneven stabilization at the stabilizing process.

It is not necessarily clear as to why the uneven stabilization can be prevented by applying the silicone compound having the above-mentioned characteristics, but it is estimated as follows. That is, the uneven stabilization in the stabilizing process is caused by that the oxygen permeation into the fiber bundle is prevented to produce a portion where the oxygen is not supplied sufficiently. That is, the silicone oil agent penetrates between the single fibers and functions like a sealing agent. In general, silicone oil agent is imparted just before the drying process in the spinning process and subjected to a heat drying treatment. Conventional oil agents contain a silicone compound having a high kinematic viscosity as the base compound. For that reason, extending speed of oil drops of the oil agent on the precursor fiber is slow, and the oil agent may cure before being formed into a smooth film, and accordingly, a surface unevenness such that the shape of the oil drop is reflected may be left on the precursor fiber. It is understood that this convex portion of the precursor fiber surface prevents oxygen supply into the fiber bundle in the stabilizing process, and as a result, the uneven stabilization is caused. It is understood that, in the oil agent of this embodiment, by containing the low kinematic viscosity silicone compound as the base compound, it is possible to form a smooth film free from a surface unevenness, and accordingly, the uneven stabilization can be prevented.

On the other hand, the inventors found that, only by that the silicone compound has a kinematic viscosity of the above-mentioned range, it is insufficient to prevent the uneven stabilization. It is understood that, if the silicone compound is of a low kinematic viscosity, although the oil agent forms a smooth film, it flows and accumulates thickly between the single fibers, and as a result, the oxygen supply into the fiber bundle is prevented. In the silicone compound of this embodiment, by being the difference of osicillation period of pendulum T between 30° C. and 180° C. is in the above-mentioned range, it is possible to prevent such a flow of the oil agent. The difference of osicillation period of pendulum T between 30° C. and 180° C. is reflected in curing behavior at heating, and the greater the difference of osicillation period, the easier the curing by heat, i.e., it is indicated that cross-linking is easy. On the contrary, the smaller the difference of osicillation period of pendulum between 30° C. and 180° C., the more difficult to be cured by heat, i.e., it is indicated that cross-linking is difficult. It is understood that the silicone compound of this embodiment is easier to be cured than silicone compounds used in conventional oil agent, and prevents a flow of the above-mentioned oil agent, and prevents to thickly accumulate the oil agent between the single fibers to prevent the uneven stabilization. However, if the curing of the silicone compound is progressed significantly, a bind between the single fibers with each other is increased on the contrary, and as a result, an uneven stabilization may be produced, and accordingly, it is preferable that the difference of osicillation period T is in an appropriate range.

That is, the oil agent of this embodiment forms a smooth film, and since the film does not deform, it becomes possible to prevent uneven stabilization.

The low kinematic viscosity silicone compound is not especially limited as far as it satisfies the above-mentioned characteristics, but the following compounds are preferably used.

As the silicone compound, those having polydimethyl siloxane as basic structure and a portion of methyl group is modified, are preferably used. As the modifying groups, amino group, alicyclic epoxy group, alkylene oxide group or the like are preferable, and further, those capable of raising a cross-linking reaction by heat are preferably used. It may be a silicone compound having a plural of modified groups, or silicone compounds having different modified groups may be mixed and used.

In view of uniform deposition to the precursor fiber, it is preferable to use an amino-modified silicone. As the modifying group, it may be monoamine type or polyamine type, but especially, a modifying group shown in the following general formula is preferably used. That is, it is expressed by general formula, -Q-(NH-Q′)ₚ—NH₂, where Q and Q′ are same or different divalent hydrocarbon group with 1 to 10 carbons, P is an integer of 0 to 5. It is understood that the amino group functions as a starting point of cross-linking reaction, and as the amount of modification becomes higher, the cross-linking reaction is more accelerated, but since the silicone oil agent may fall off to drying rollers and may increase so-called gum-up which induce a wind up to the rollers, the amount of modification is, when the amount of terminal amino group is converted into the weight of —NH₂, preferably 0.05 to 110 wt %, and 0.1 to 5 wt % is more preferable. In addition, the lower the kinematic viscosity of the amino-modified silicone at 25° C., the smoother surface film of the oil agent is formed, but concretely 10 to 10000 cSt is preferable, 100 to 2000 cSt is more preferable and 300 to 1000 cSt is still more preferable.

On the other hand, conventionally, an alkylene oxide-modified silicone is low in its residual ratio after heating, and has not been actively used. However, when it is viewed not in total residual amount but in silicon residual amount, an alkylene oxide-modified silicone is high in the silicon residual amount up to the pre-carbonization process. On the other hand, in view of preventing fusion-bonding between single fibers, since it is important to be high in silicon residual amount, it is preferable to use an alkylene oxide-modified silicone. The lower the kinematic viscosity at 25° C. of the alkylene oxide-modified silicone, the smoother surface film of the oil agent is formed, and concretely, 10 to 1000 cSt is preferable, 50 to 800 cSt is more preferable and 100 to 500 cSt is still more preferable. Furthermore, as an amount contained of the alkylene oxide-modified silicone to the amino-modified silicone 100 parts by weight, 15 to 900 parts by weight is preferable. As the lower of the amount contained to the amino-modified silicone 100 parts by weight, 25 parts by weight or more is more preferable and 30 parts by weight or more is still more preferable. As the upper limit of the amount contained to the amino-modified silicone 100 parts by weight, 200 parts by weight or less is more preferable, 100 parts by weight or less is still more preferable and 40 parts by weight or less is especially preferable. As a range of the amount contained to the amino-modified silicone 100 parts by weight, 25 to 200 parts by weight is more preferable, 30 to 100 parts by weight is still more preferable and 30 to 40 parts by weight is especially preferable. If it exceeds 900 parts by weight, it delays the cross-linking reaction of other silicone, and the effect of the present invention may become difficult to be attained. On the other hand, if it is less than 15 parts by weight, it may become difficult to obtain a significant improvement of the heat resistant silicon residue ratio.

As the alkylene oxides used for the alkylene oxide-modified silicone, polymer of ethylene oxide (hereafter, referred to as EO), polymer of propylene oxide or block copolymer thereof are preferably used. In particular, EO is preferable.

Furthermore, it is also preferable to use an alicyclic epoxy-modified silicone, in view of fiber bundle formation. As the amount of modification, 0.05 to 10 wt % is preferable and 0.1 to 5 wt % is more preferable. And, regarding the kinematic viscosity at 25° C. of the alicyclic epoxy-modified silicone, it should be as high as possible in view of fiber bundle formation, and 100 to 10000 cSt is preferable, 500 to 6000 cSt is more preferable and 1000 to 4000 cSt is still more preferable. Regarding a ratio of the alicyclic epoxy-modified silicone to the total silicone compound 100 parts by weight, adding 0 to 20 parts by weight may exhibit a sufficient effect and is preferable. Regarding the lower limit of the amount contained, 3 parts by weight or more to the total silicone compound 100 parts by weight is more preferable, 6 parts by weight or more is still more preferable. As the upper limit of the amount contained, 15 parts by weight or less to the total silicone compound 100 parts by weight is more preferable, 10 parts by weight or less is still more preferable. As the range of the amount contained, 3 to 20 parts by weight to the total silicone compound 100 parts by weight is more preferable, 3 to 15 parts by weight is still more preferable, 6 to 10 parts by weight is especially preferable. If the amount contained of the alicyclic epoxy-modified silicone exceeds 20 parts by weight, it delays cross-linking reaction of other silicone, and the effect of the present invention may become difficult to be attained.

As the alicyclic epoxy group used for the alicyclic epoxy-modified silicone, a compound of which alicyclic group such as cyclohexene oxide group is epoxidized is preferably used.

Furthermore, in order to further increase the preventing effect of fusion-bonding between the single fibers, it is preferable to use a low kinematic viscosity silicone compound of this embodiment as the base compound in combination with the above-mentioned liquid fine particle or the above-mentioned thermosensitive polymer. It is most effective and preferable to use all of the low kinematic viscosity silicone compounds of this embodiment, the above-mentioned liquid fine particle and the above-mentioned thermosensitive polymer in combination.

In the oil agent of the present invention, other than the above-mentioned components, components such as a lubricating agent, a moisture absorbent, a viscosity controlling agent, a releasing agent, a spreading agent, an antioxidant, an antibacterial agent, an antiseptic agent, a corrosion inhibitor and a pH controlling agent may be included in a range which does not impair the effect of the present invention.

The production method of such an oil agent is not especially limited and known mixing methods or emulsification methods of chemical substances can be applied. For example, as production apparatus, a stirring propeller, a Homo-mixer and a homogenizer or the like can be used. And, as its process, if an emulsification is necessary, an emulsification by forced stirring, a phase inversion emulsification method which can easily produce a uniform fine particle diameter, or the like can be applied. For convenience, they are separately prepared into oil agent component 1 consisting of the base compound and the liquid medium, oil agent component 2 consisting of the thermosensitive polymer and the liquid medium and oil agent component 3 consisting of the liquid fine particle and the liquid medium, and after the respective oil agents are prepared by properly selecting and adopting from the above-mentioned apparatuses and processes, the oil agent component 1 and the oil agent component 2, or the oil agent component 1 and the oil agent component 3, or the oil agent components 1 to 3 may be mixed. Or, after preparing the above-mentioned oil agent component 1, by properly selecting and adopting from the above-mentioned apparatuses or processes, to the oil agent component 1, the thermosensitive polymer, or the oil agent component 3, or the thermosensitive polymer and the oil agent component 3 may be mixed to produce an oil agent. Or, three of the base compound, the thermosensitive polymer and the liquid medium are added at first, mixed and emulsified by properly selecting and adopting from the above-mentioned apparatuses and processes, and the oil agent component 3 prepared appropriately and separately may be mixed to prepare an oil agent. However, regarding the process related to the thermosensitive polymer, it is preferable to carry out at a temperature not higher than the cloud point or the lower critical solution temperature of the thermosensitive polymer, since a uniform oil agent as to the thermosensitive polymer can be obtained.

Next, the production method of carbon fiber is explained.

The oil agent of the present invention may be imparted in any processes in the spinning process of the precursor fiber, but in order to effectively prevent adhesion or fusion-bonding of the single fibers with each other, it is preferable to impart it before a process where a heat which, without an oil agent, may fusion-bond the single fibers of precursor fiber yarn with each other is added. As the precursor of carbon fibers, polyacrylonitrile-based fiber, pitch-based fiber, cellulose-based fiber, etc., are known, but in any case the oil agent of the present invention can preferably be imparted before a process in which a heat as the above-mentioned is added, for example, before stabilizing process or infusing process. Hereafter, a preferable embodiment is explained with reference to, as an example, a case applied to polyacrylonitrile-based fiber which is used as a precursor fiber for particularly high performance carbon fiber.

After a precursor fiber is produced by spinning a spinning dope containing polyacrylonitrile-based polymer by a predetermined spinning method, the above-mentioned oil agent is imparted to the fiber yarn obtained by washing with water in a swelled state with water, and then subjected to a heat drying treatment at 130 to 200° C.

As components of the polyacrylonitrile-based polymer, a polymer in which 95 mol % or more, more preferably 98 mol % or more of acrylonitrile and 5 mol % or less, more preferably 2 mol % or less of a stabilization accelerating component which accelerates the stabilization and copolymerizable with acrylonitrile, are copolymerized can preferably used. As such a stabilization accelerating component, vinyl group containing compound is preferably used. As concrete example of the vinyl group containing compound, acrylic acid, methacrylic acid, itaconic acid or the like are mentioned, but is not limited thereto. And, ammonium salt of acrylic acid, methacrylic acid, or itaconic acid which is partly or entirely neutralized with ammonia is more preferably used as the stabilization accelerating component.

The spinning dope can be obtained by applying a solution polymerization, suspension polymerization, emulsion polymerization or the like. As solvent used for the spinning dope, an organic or inorganic solvent can be used, but, especially, it is preferable to use an organic solvent. As the organic solvent, e.g., dimethyl sulfoxide, dimethyl formamide, dimethyl acetamide or the like are used, and in particular, dimethyl sulfoxide is preferably used.

As spinning method, semi-wet spinning method or wet spinning method is preferably applied. The semi-wet spinning method is more preferably used because it can produce a precursor fiber of smoother surface in high productivity.

A coagulated fiber is obtained by extruding the spinning dope from a spinneret directly or indirectly into a coagulation bath. It is preferable, for convenience, to constitute the coagulation bath liquid with the solvent used for the spinning dope and a coagulation accelerating component. It is preferable to use water as the coagulation accelerating component. The ratio of the spinning solvent and the coagulation accelerating component in the coagulation bath and the coagulation bath liquid temperature are appropriately selected and applied in consideration of denseness, surface smoothness and spinnability of the obtained coagulated fiber.

It is appropriate that the obtained coagulated fiber is washed with water and drawn in a single or plural number of water baths controlled at 20 to 98° C. The draw ratio can be appropriately determined in a range in which fiber breakage or adhesion between single fibers does not occur, but in order to obtain a precursor fiber of smoother surface, 5 times or less is preferable, 4 times or less is more preferable and 3 times or less is still more preferable. Furthermore, in view of increasing density of the obtained precursor fiber, it is preferable to set the maximum temperature of the drawing bath to 50° C. or more and 70° C. or more is still more preferable.

The above-mentioned oil agent is imparted to the fiber yarn in a swelled state with water after washing with water and drawing. The imparting means may appropriately be selected and applied to impart uniformly inside the fiber yarn, but for convenience of function of the thermosensitive polymer as above-mentioned, it is practically preferable to impart at the oil agent temperature of 35° C. or less. The lower limit of the temperature is about the coagulation temperature of the liquid medium. As concrete imparting means, the concentration of the oil agent component is controlled to 0.01 to 10 wt % using a dispersion medium such as water, and imparting means to the fiber yarn in swelled state with water by immersion method, spray method, touch roll method, oiling method by guide or the like is adopted. In case where the concentration of the oil agent component is too low, the effect of preventing fusion-bonding between single fibers of the precursor fiber yarn decreases. In case where the concentration of the oil agent component is too high, the viscosity of the oil agent becomes too high to decrease flowability, and it becomes impossible to uniformly treat within the fiber bundle of the precursor fiber.

The amount of deposition of the oil agent is controlled such that the ratio of the oil agent component except the liquid medium to the dry weight of the precursor fiber is preferably 0.1 to 5 wt %, more preferably 0.3 to 3 wt %, still more preferably 0.5 to 2 wt %. If the amount of deposition of the oil agent is too small, the fusion-bonding between the single fibers with each other arises and tensile strength of the obtained carbon fiber may decrease. If the amount of deposition of the oil agent is too high, the oil agent covers between the single fibers, and the oxygen permeation at the stabilizing process may be impaired.

The fiber yarn imparted with the oil agent should be dried quickly. The drying method is not especially limited, but a directly contacting means with a plural number of heated rollers is preferably applied. Since it is preferable that the drying temperature is as high as possible in view of productivity, it is preferable to set it high in the range in which a fusion-bonding between single fibers does not occur. As the drying temperature, concretely, 120 to 220° C. is preferable, 140 to 210° C. is more preferable and 1.60 to 200° C. is still more preferable. If the drying temperature exceeds 220° C., an adhesion between single fibers may arise. If the drying temperature is lower than 120° C., the drying takes a long time and it may not be efficient. As the heating time, 5 to 120 seconds is preferable, 10 to 90 seconds is more preferable and 15 to 60 seconds is still more preferable. If the heating time is less than 5 seconds, the effect of drying and densification is low. Even if the heating time exceeds 120 seconds, the effect of drying and densification may saturate. This time is appropriately determined according to heating temperature or heating system (for example, whether it is a contact heating or non-contact heating or the like), etc. Regarding the heating system, both of non-contact system such as a tenter or infra-red heating system, in which the precursor fiber bundle is passed through the air heated by an electric heater or steam, and contact system such as a plate type heater or a drum type heater are used, but the contact system is more preferable in view of heat transfer efficiency.

It is preferable to further post-draw the dried fiber yarn in pressurized steam or under dry heat in view of density of the obtained precursor fiber or improving productivity. The steam pressure, temperature or post-draw ratio may be appropriately selected in a range in which a fiber breakage or fuzz generation does not arise.

Single filament fineness of the precursor fiber is preferably 0.1 to 2.0 dtex, more preferably 0.3 to 1.5 dtex, still more preferably 0.5 to 1.2 dtex. The finer the single filament fineness, the more advantageous for improving tensile strength or modulus of the obtained carbon fiber, but the productivity may decrease. Therefore, it is necessary to select single filament fineness of the precursor fiber in consideration of the balance of performance and cost.

And, number of single fibers constituting fiber yarn of the precursor fiber is, preferably, 1000 to 96000, more preferably, 12000 to 48000 and still more preferably, 24000 to 48000. Where, the number of single fibers constituting fiber yarn of the precursor fiber means the number of single fibers just before the stabilization treatment. When the number of single fibers is too small, the productivity may decrease. When the number of single fibers is too big, an uneven stabilization may arise in the stabilizing process.

By the method as above-mentioned, the produced precursor fiber is subjected to the stabilization treatment to convert it to a stabilized fiber.

The stabilization treatment is, usually, carried out under oxygen-containing atmosphere, preferably under air atmosphere, at a temperature of 200 to 400° C., preferably at 200 to 300° C. It is preferable to carry out stabilization at a temperature lower by 10 to 20° C. than the temperature at which the fiber yarn starts fiber breakage by accumulation of reaction heat, in view of cost reduction and improvement of performance of the obtained carbon fiber. Regarding the time for the stabilization treatment, in view of productivity and performance of the obtained carbon fiber, 10 to 100 minutes is preferable and 30 to 60 minutes is more preferable. The time of the stabilization treatment means the total time in which the fiber yarn stays in stabilization furnace. When this time is too short, structural difference between oxidized outer portion and insufficiently oxidized inner portion of each single fiber becomes significant as a whole, and the effect of the present invention becomes difficult to be attained. The draw ratio of the fiber yarn in the process of stabilization treatment is, preferably 0.85 to 1.10, more preferably 0.88 to 1.06 and still more preferably 0.92 to 1.02. By increasing such a draw ratio, it is possible to increase the modulus of carbon fiber by a same degree of heat treatment.

Following the stabilizing process, the fiber is transferred to a carbonization process in which the obtained stabilized fiber is carbonized to convert to a carbon fiber. It is also preferable to provide a pre-carbonization process in which, before the carbonization process, the stabilized yarn is treated under an inert atmosphere of 300 to 800° C., preferably, under nitrogen or argon atmosphere. It is appropriate to set draw ratio in this pre-carbonization process to, preferably 0.90 to 1.25, more preferably 1.00 to 1.20 and still more preferably 1.05 to 1.15, in view of improving performance of the obtained carbon fiber.

The carbonization treatment is, usually, carried out under an inert atmosphere and at a temperature of 1000° C. or more, preferably, at 1000 to 2000° C. Its maximum temperature is appropriately selected and determined depending on required characteristics of desired carbon fiber, but if it is too low, tensile strength and modulus of the obtained carbon fiber may decrease. It is appropriate to set the draw ratio in process of the carbonization treatment to, preferably 0.95 to 1.05, more preferably 0.97 to 1.02 and still preferably 0.98 to 1.01, in view of improving performance of the obtained carbon fiber.

The carbon fiber of the present invention thus obtained has a coefficient of variance of single filament modulus distribution measured by the method mentioned later is 10% or less. The modulus of carbon fiber greatly depends on internal material structure, but between single fibers, the internal structure is not uniform, and a nonuniformity of orientation of graphite structure arises. It is estimated that such an orientation is affected by fiber tension in stabilizing process and carbonization process. It is understood that unevenness between single fibers arises in oxidation reaction or inter-molecular cross-linking in the stabilizing process to cause an unevenness of tension between single fibers in the stabilizing process and the carbonization process, and it causes the unevenness of the orientation. In the carbon fiber of the present invention, compared to conventional carbon fibers, the fusion-bonding between single fibers or adhesion in precursor fiber yarn is few and the orientation unevenness such as the above-mentioned is prevented, and single filament modulus distribution becomes narrow. When the coefficient of variance of single filament modulus of carbon fiber is more than 10%, reliability of carbon fiber reinforced composite material obtained from said carbon fiber becomes low. As the coefficient of variance of single filament modulus is, 8% or less is preferable and 6% or less is more preferable. It is preferable that the coefficient of variance of single filament modulus is as low as possible in view of reliability of carbon fiber reinforced composite material, and 0% is most preferable, but if it is less than 0.1%, its effect substantially saturates and accordingly, 0.1% or more is a practical value. It is more preferable that the coefficient of variance of single filament modulus is 4% or more.

Furthermore, as to average value of single filament modulus of carbon fiber, 400 GPa or less is preferable. In order to obtain a carbon fiber of a high average modulus, a method of carbonization at high temperature in carbonization process and a method of carbonization while subjecting to a drawing treatment are mentioned, but in case of carbonization treatment at a maximum temperature of 2000° C. or more, a decrease of compressive strength becomes significant. The average value of single filament modulus of carbon fiber is, more preferably, 360 GPa or less and still more preferably, 320 GPa or less. When carbonization treatment is carried out such that the single filament modulus of carbon fiber would be in the above-mentioned range, it is possible to effectively prevent both of decrease of the compressive strength and unevenness of the single filament modulus of the obtained carbon fiber.

In case where a carbon fiber of higher modulus is desired, following to the carbonization treatment, it is possible to carry out a graphitization treatment. The graphitization treatment is, usually, carried out under an inert atmosphere and at a temperature of 2000 to 3000° C. Its maximum temperature is appropriately selected and determined according to required characteristics of desired carbon fiber. Draw ratio in the process of graphitization treatment may be appropriately selected in a range in which a quality down such as fuzz generation does not occur, according to required characteristics of desired carbon fiber.

By carrying out a surface treatment to the obtained carbon fiber, it is possible to increase adhesive strength with, matrix when made into a composite material. As the method of surface treatment, a gaseous or liquid phase treatment can be adopted, but when productivity and quality unevenness are considered, a liquid phase treatment, especially electrolytic treatment (anode oxidation treatment) is preferably adopted.

As electrolyte used in the electrolytic treatment, acids such as sulfuric acid, nitric acid, hydrochloric acid, alkalis such as sodium hydroxide, potassium hydroxide or tetraethyl ammonium hydroxide or aqueous solution containing salt thereof can be used. Among them, an aqueous solution containing ammonium ion is especially preferable. Concretely, for example, aqueous solution containing ammonium nitrate, ammonium sulphate, ammonium persulfate, ammonium chloride, ammonium bromide, ammonium dihydrogen phosphate, ammonium phosphate dibasic, ammonium bicarbonate, ammonium carbonate or mixture thereof can be preferably used.

In the electrolytic treatment, amount of electric to be charged to carbon fiber varies according to carbon fiber used, for example, the higher the degree of carbonization of carbon fiber, the more amount of electric to be charged becomes necessary. In general, it is preferable to control the amount of electric such that a surface oxygen concentration O/C and a surface nitrogen concentration N/C of carbon fiber measured by X-ray photoelectron spectroscopic method (ESCA) would be in the range of 0.05 to 0.40 and 0.02 to 0.30, respectively, in view of improving adhesion characteristics. By satisfying these conditions, adhesion between carbon fiber and matrix becomes in an appropriate level when they are made into a composite material. Accordingly, a defect that the adhesion between carbon fiber and matrix becomes too strong and causes a very brittle breakage to decrease tensile strength of composite material in longitudinal direction or a defect that, although the tensile strength of composite material in longitudinal direction is high, the adhesion between carbon fiber and matrix is too low, and mechanical characteristics in not longitudinal direction of composite material is not exhibited, can be prevented, and composite material characteristics of good balance in longitudinal and not longitudinal directions is realized.

The obtained carbon fiber is, further, as required, subjected to a sizing treatment. As the sizing agent, a sizing agent compatible with the matrix is preferable, and it is selected together with the matrix and used.

The thus obtained carbon fiber can be molded as a composite material after prepreging, or after made into a preform such as woven fabric, it can also be molded into a composite material by hand lay-up method, pultrusion method, resin transfer molding method or the like. And it can also be molded into a composite material by filament winding method or by injection molding after made into chopped fiber or milled fiber.

The composite materials in which carbon fiber obtained by the present invention is used, can preferably be used for sports applications such as golf shaft or fishing rod, aerospace applications, structural member applications for car such as hood or propeller shaft, energy related applications such as fly wheel and CNG tank.

### EXAMPLES

Hereafter, the present invention is explained in more concretely with reference to Examples.

Where, in those examples, each characteristics were measured according to the following method. Furthermore, as a kinematic viscosity, the catalogue values of silicone compounds of silicone compound makers were used.

### <Measurement of the Difference of Osicillation Period of Liquid Fine Particle by the Free Damped Oscillation Method of Rigid-Body Pendulum>

The osicillation period is measured by the rigid-body pendulum type physical properties tester RPT-3000 produced by A&D Co. according to the free damped oscillation method of rigid-body pendulum. The liquid fine particles used for the measurement may be used as they are in case where they are not mixed with the dispersion medium, but in case where they are mixed with the dispersion medium to form an emulsified liquid, about 1 g of the emulsified liquid is taken into an aluminum container having a diameter of about 60 mm and a height of about 20 mm and dried at 40° C. for 10 hours. Next, on a coating substrate made of zinc-plated steel plate of a length 5 cm, width 2 cm and thickness 0.5 mm (STP-012 produced by A&D Co.), the liquid fine particle was coated on entire surface in the substrate width direction so that the thickness would be 20 to 30 μm to prepare a coated plate. After the coating, the coated plate was quickly set to the tester to start the measurement. The tester was adjusted to 30° C. beforehand, and after the coated plate and the pendulum were set, heated to 300° C. at a rate of 10° C./min. During the measurement, the cycle was continuously measured in 7-second interval, and from the values of cycle at 30° C., 200° C. and 300° C., a difference of osicillation periods between 30° C. and 200° C. or between 30° C. and 300° C. were calculated, respectively. The measurement was repeated seven times, respectively, taking off the maximum and minimum values of the difference of osicillation period, and the average of 5 times was taken as the value of difference of osicillation period. Where, the following one is used as the pendulum.

Edge used: Knife-shaped edge (RBE-160 produced by A&D Co.)

Weight of pendulum/moment of inertia: 15 g/640 g·cm (FRB-100 produced by A&D Co.).

### <Measurement of Difference of Osicillation Period T of Silicone Compound by the Free Damped Oscillation Method of Rigid-Body Pendulum>

A osicillation period was measured according to the free damped oscillation method of rigid-body pendulum using the rigid-body pendulum type physical properties tester RPT-3000 produced by A&D Co. The silicone compound used for the measurement may be used as it is in case where it is in a condition not mixed with the liquid medium, but in case where it is mixed with the liquid medium to form a solution or an emulsified liquid, about 1 g of the solution or emulsified liquid is taken into an aluminum container of a diameter about 60 mm, a height about 20 mm, and dried at 40° C. for 10 hours. Next, on the same coating substrate as above mentioned, the dried sample is coated on entire surface in the substrate width direction so that the thickness would be 20 to 30 μm to prepare a coated plate. After the coating, the coated plate is quickly set to the tester to start the measurement. The tester is adjusted to 30° C. beforehand, and after the coated plate and the pendulum are set, heated to 180° C. at a rate of 50° C./min and kept at 180° C. for 20 minutes. During the measurement, the cycle is continuously measured in 7-second interval, and from the value of cycle at 30° C. and the value of cycle after keeping at 180° C. for 20 minutes, the difference of osicillation period T between 30° C. and 180° C. is calculated. The measurement was repeated seven times, respectively, the maximum and minimum values are taken off, and the average of the 5 times was taken as the value of difference of osicillation period T. Where, the same one as the above mentioned was used as the pendulum.

The difference of osicillation period T is determined by the following equation.

T=T30−T180

T30: the osicillation period (seconds) at 30° C.

T180: the osicillation period (seconds) after heat treatment at 180° C. for 20 minutes

### <Measurement of Hydrodynamical Particle Diameter of Liquid Fine Particle or of Base Compound>

According to the dynamic light scattering method, an average particle diameter is measured by using FPAR-1000 made by Otsuka Electronics Co. Measurement temperature is 25° C., and a diluted solution type probe is used as the probe. The liquid fine particle or base compound is diluted with a similar dispersion medium to the sample so that its content will be 0.01 wt %. Cumulant method is used to analyze, and the cumulant average particle diameter is taken as the hydrodynamical particle diameter.

### <Measurement of Coefficient of Variance of Single Filament Modulus of Carbon Fiber>

The single filament modulus of carbon fiber is determined as follows according to JIS R7601 (1986). That is, at first, a carbon fiber bundle of about 20 cm length is equally divided into 4 bundles, and 50 single fibers are sampled from the 4 bundles in order. At this time, the sampling is carried out equally from the all over the bundles. The sampled single fiber is fixed to a substrate paper with holes with an adhesive. The substrate paper on which the single fiber is fixed is set to a tensile tester and subjected to a tensile test at a sample length 25 mm, strain speed 1 mm/min and by a number of single fiber samples 50. The modulus is defined by the following equation.

Modulus=(Strength measured)/(cross-sectional area of single fiber×elongation measured)

Regarding the cross-sectional area of single fiber, the weight per unit length (g/m) of the fiber bundle to be measured is divided by the density (g/m³), and further divided by the number of filament to determine the cross-sectional area of single fiber. The density was measured according to the Archimedes method with o-dichloroethylene as the specific gravity liquid. With the 50 values of modulus thus measured, the coefficient of variance is determined by the following equation.

Coefficient of variance (%)=(standard deviation of modulus)/(average value of modulus)×100

And, the strand tensile strength and tensile modulus of the carbon fiber are measured as follows. A carbon fiber bundle is impregnated with an epoxy resin composition of the following composition and cured at a temperature of 130° C. for 35 minutes to obtain a strand. Tensile tests are carried out for the respective 6 strands based on JIS R7601 (1986), and the strengths and moduli obtained by the respective tests are averaged and they are taken as the tensile strength and the tensile modulus of the carbon fiber.

* resin composition

| | |
|---|---|
| 3,4-epoxy cyclohexyl methyl 3,4-epoxy | 100 parts by weight |
| cyclohexyl carboxylate (ERL-4221 produced by | |
| Union Carbide Corp.) | |
| boron trifluoride monoethyl amine (produced | 3 parts by weight |
| by Stella Chemifa Corp.) | |
| acetone (produced by Wako Pure Chemical | 4 parts by weight |
| Industries, Ltd.) | |

### Example 1

An oil agent for carbon fiber precursor prescribed below is prepared.

| | |
|---|---|
| amino-modified silicone | 66 parts by weight |
| alicyclic epoxy-modified silicone | 28 parts by weight |
| alkylene oxide-modified silicone | 5 parts by weight |
| nonionic surfactant | 30 parts by weight |
| water | 4000 parts by weight |

As the amino-modified silicone, a silicone compound obtained by substituting a part of side chain of dimethyl silicone with the amino group shown in Chemical formula J mentioned later, was used. The amino-modified silicone had an amino equivalent of 2000 mol/g and a kinematic viscosity at 25° C. of 1000 cSt. As the alicyclic epoxy-modified silicone, a silicone compound obtained by substituting a part of side chain of a dimethyl silicone with an alicyclic epoxy group shown in Chemical formula 2 mentioned later, was used. The alicyclic epoxy-modified silicone had an epoxy equivalent of 6000 mol/g and a kinematic viscosity at 25° C. of 6000 cSt. As the alkylene oxide-modified silicone, a silicone compound obtained by substituting a part of side chain of dimethyl silicone with polyethylene oxide group shown in Chemical formula 3 mentioned later, was used. The alkylene oxide-modified silicone had a ratio of alkylene oxide portion to the total weight of 50 wt % and a kinematic viscosity at 25° C. of 300 cSt. As the nonionic surfactant, polyoxyethylene alkyl phenyl ether was used.

An emulsified liquid was prepared by adding the above-mentioned three kinds of silicone compound, surfactant and water, and by using a Homo-mixer and homogenizer. To this emulsified liquid, an emulsified liquid KM902 (produced by Shin-Etsu Chemical Co.) consisting of dimethyl silicone 10 parts by weight (kinematic viscosity at 150° C. is 90000 cSt), nonionic surfactant 1.2 parts by weight, water 8.8 parts by weight was added and stirred to obtain an oil agent. The hydrodynamical particle diameter of KM902 was, as a result of measurement by a particle size distribution measuring instrument, 0.6 μm. And, the difference of osicillation period of pendulum between 30° C. and 200° C., measured by the free damped oscillation method of rigid-body pendulum, was 0.02, and the same difference of osicillation period of pendulum between 30° C. and 300° C. was 0.02.

A copolymer consisting of acrylonitrile 99.5 mol % and itaconic acid 0.5 mol % was obtained by a solution polymerization in dimethyl sulfoxide solvent to obtain a spinning dope of a concentration of 22 wt %. After the polymerization, ammonia gas was introduced to adjust to pH 8.5 to neutralize the itaconic acid and introduce ammonium groups into the polymer component to improved the hydrophilic property of the spinning dope. The obtained spinning dope was once extruded in the air through a spinneret having 4000 holes of 0.15 mm diameter at a temperature of 40° C. and after allowing to pass through a space of about 4 mm distance, coagulated by semi-wet spinning in which the extrudate is introduced in a coagulation bath consisting of 35 wt % aqueous dimethyl sulfoxide solution controlled at a temperature of 3° C. After washing the obtained coagulated fiber with water, it was drawn 3 times in a hot water of 70° C., and by further passing through an oil bath consisting of the above prepared oil agent, the oil agent was imparted by a dip-nip method. Furthermore, by using a heated roller of 180° C., a drying treatment of contact time of 40 seconds was carried out. By drawing the obtained dried fiber in a pressurized steam of 0.4 MPa, adjusted the total draw ratio in the entire fiber production to 14 times, and obtained a precursor fiber yarn of a single filament fineness 0.7 dtex and a number of single fiber 4000. Where, the deposited amount in pure component of the oil agent to the obtained precursor fiber was 1.0 wt %.

After gathering 6 yarns of the obtained precursor fiber to make the number of single fiber to 24000 fibers, converted into a stabilized fiber by heating in air at 240 to 280° C. The time for the stabilization treatment was 40 minutes and the draw ratio in the stabilization treatment was controlled to 1.00.

Furthermore, after this stabilized fiber was subjected to a pre-carbonization treatment by heating at 300 to 800° C. in nitrogen atmosphere, it was subjected to a carbonization treatment by heating in nitrogen atmosphere of the maximum temperature 1500° C. The draw ratio in the pre-carbonization treatment process was 1.10 and the draw ratio in the carbonization treatment process was 0.97. Furthermore, the fiber obtained by the carbonization treatment was subjected to an anode oxidation treatment in aqueous sulfuric solution at an amount of electric charge of 10 coulomb/g-CF to obtain a carbon fiber. During these processes, a notable generation of fuzzes or breakages of the carbon fiber which would affect operation efficiency was not observed. The tensile strength of the obtained good quality carbon fiber was 6.7 GPa, and the tensile modulus was 320 GPa.

### Comparative Example 1

A carbon fiber was prepared in the same way as Example 1 except without using KM902 used in Example 1. As a result, many fuzzes were generated in the pre-carbonization process. The tensile strength of the obtained carbon fiber was 6.1 GPa and the tensile modulus was 320 GPa.

### Example 2

A carbon fiber was obtained in the same way as Example 1 except using the oil agent prescribed below instead of the oil agent for the carbon fiber precursor used in Example 1.

| | |
|---|---|
| amino-modified silicone | 100 parts by weight |
| nonionic surfactant | 30 parts by weight |
| water | 4000 parts by weight |

As the amino-modified silicone, the silicone compound in which a part of side chain of dimethyl silicone is substituted with the amino group shown in Chemical formula 1 mentioned later was used. The amino-modified silicone had an amino equivalent of 2000 mol/g and a kinematic viscosity at 25° C. of 3500 cSt. An emulsified liquid was prepared by adding the above-mentioned silicone, surfactant and water and by using a Homo-mixer and homogenizer. To this emulsified liquid, KM902 (produced by Shin-Etsu Chemical Co.) was added and stirred to obtain an oil agent.

In the carbon fiber production, a notable generation of fuzzes or breakages of the carbon fiber which would affect operation efficiency was not observed. The tensile strength of the obtained good quality carbon fiber was 6.4 GPa, and the tensile modulus was 320 GPa.

### Comparative Example 2

A carbon fiber was obtained in the same way as Example 2 except without using KM902 used in Example 2. As a result, many fuzzes were generated in the pre-carbonization process and a carbon fiber of good quality could not be obtained.

### Example 3

An oil agent for precursor fiber of carbon fiber prescribed below was prepared.

base compound

| | |
|---|---|
| amino-modified silicone | 50 parts by weight |
| alicyclic epoxy-modified silicone | 25 parts by weight |
| alkylene oxide-modified silicone | 25 parts by weight |
| nonionic surfactant | 30 parts by weight |
| thermosensitive polymer | |
| N-isopropyl acrylamide-based copolymer | 0.5 parts by weight |
| water | 4000 parts by weight |

As the amino modified silicone, a silicone compound in which a part of side chain of dimethyl silicone is substituted with the amino group shown in Chemical formula 1 mentioned later was used. The amino-modified silicone has an amino equivalent of 2000 mol/g and a kinematic viscosity at 25° C. of 1000 cSt. As the alicyclic epoxy-modified silicone, a silicone compound obtained by substituting a part of side chain of a dimethyl silicone with an alicyclic epoxy group shown in Chemical formula 2 mentioned later, was used. The alicyclic epoxy-modified silicone had an epoxy equivalent of 6000 mol/g and a kinematic viscosity at 25° C. of 6000 cSt. As the alkylene oxide-modified silicone, a silicone compound obtained by substituting a part of side chain of dimethyl silicone with polyethylene oxide group shown in Chemical formula 3 mentioned later, was used. The alkylene oxide-modified silicone had a ratio of alkylene oxide portion to the total weight of 50 wt % and a kinematic viscosity at 25° C. of 300 cSt. As the nonionic surfactant, an ethylene oxide (hereafter, abbreviated as EO) additive (same weight mixture of additives with added mols of 10, 8 and 6) of nonyl phenol was used. As the N-isopropyl acrylamide-based copolymer, copolymer of N-isopropyl acrylamide 97 mol % and N,N-dimethyl amino propyl acrylamide 3 mol % was used.

The above-mentioned 3 kinds of silicone compound and the surfactant were stirred with a propeller at 25° C. and 3500 parts by weight of 25° C. water was added slowly. On the other hand, N-isopropyl acrylamide-based copolymer was added to 500 parts by weight of 25° C. water at 25° C. and stirred until dissolved, and the solution was added to the emulsified liquid consisting of the above-mentioned silicone compound, the surfactant and water.

The average particle diameter of the obtained oil agent was 0.2 μm, as a result of measurement by a particle size distribution measuring instrument.

This oil agent was imparted to a polyacrylonitrile-based fiber (0.7 dtex, 3000 fillament) at 25° C. by dip-nip method, and successively dried at 170° C. for 30 seconds. After that, through a steam drawing of a draw ratio 5, a precursor fiber bundle for carbon fiber was obtained.

8 bundles of such a precursor fiber bundle for carbon fiber were gathered into a number of single fibers of 24000 and then, through a stabilizing process of 250° C. with a draw ratio 1.00, pre-carbonization process of 650° C. with a draw ratio 1.10 and a carbonization process of 1450° C. with a draw ratio 1.00, a carbon fiber bundle was obtained. During these processes, a notable generation of fuzzes or breakages of the carbon fiber which would affect operation efficiency was not observed. The tensile strength of the obtained good quality carbon fiber was 7.1 GPa, and the tensile modulus was 350 GPa.

### Comparative Example 3

The same procedure as Example 3 was carried out except without using the thermosensitive polymer used in Example 3. As a result, many fuzzes were generated in the pre-carbonization process and a carbon fiber having a good quality could not be obtained.

### Example 4 to 9, Comparative Example 4 to 8

Silicone oil agents having the composition ratios shown in Table 1 were prepared and differences of osicillation period T were measured. As the silicone compounds used for preparing the oil agents, 3 kinds of silicone compound, in which a part of side chain of dimethyl silicone having methyl group at its terminal is substituted by the amino group shown in Chemical formula 1 below, by the alicyclic epoxy group shown in Chemical formula 2 below or by the polyethylene oxide group shown in Chemical formula 3 below, respectively, were used. The amount of modification of the amino-modified silicone was 1.0 wt %. The amount of modification of the epoxy modified silicone was 1.0 wt %. The amount of modification of the alkylene oxide-modified silicone was 50 wt %. To the total of 100 parts by weight of the above-mentioned 3 kinds of silicone compound, 30 parts by weight of a nonionic surfactant and water were added, and by using a Homo-mixer and homogenizer, silicone oil agents having 30 wt % pure component were prepared and provided to the above-mentioned measurements.

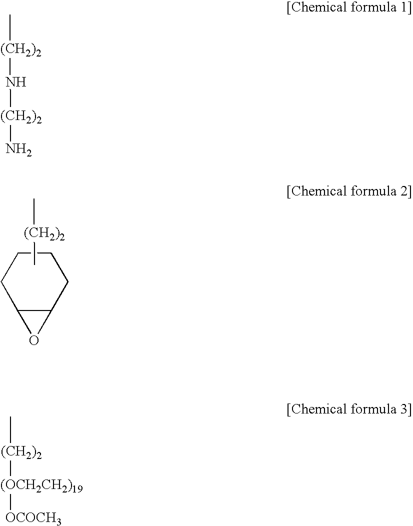

A copolymer consisting of acrylonitrile 99.5 mol % and itaconic acid 0.5 mol % was obtained by a solution polymerization in dimethyl sulfoxide solvent to obtain a spinning dope of a concentration of 22 wt %. After the polymerization, ammonia gas was introduced to adjust to pH 8.5, and neutralize the itaconic acid to introduce ammonium group into the polymer component to improve the hydrophilic property of the spinning dope. The obtained spinning dope was once extruded in the air through a spinneret having 4000 holes of 0.15 mm diameter at a temperature of 40° C. and after allowing to pass through a space of about 4 mm distance, coagulated by semi-wet spinning in which the extrudate is introduced in a coagulation bath consisting of 35 wt % aqueous dimethyl sulfoxide solution controlled at a temperature of 3° C. After washing the obtained coagulated fiber with water, it was drawn 3 times in a hot water of 70° C., and by further passing through an oil bath consisting of the above prepared oil agent, the oil agent was imparted. The concentration in the oil bath was adjusted to 2.0 wt % in pure component by diluting with water. Furthermore, by using a heated roller of 180° C., a drying treatment of contact time of 40 seconds was carried out. By drawing the obtained dried fiber in a pressurized steam of 0.4 MPa-G, adjusted the total draw ratio in the entire fiber production to 14 times, and obtained a precursor fiber yarn of a single filament fineness 0.7 dtex and a number of single fiber 24000. Where, the deposited amount in pure component of the oil agent to the obtained precursor fiber was 1.0 wt %.

The obtained precursor fiber was converted to a stabilized fiber by heating in air of 240 to 280° C. The time for the stabilization treatment was 40 minutes, and the draw ratio in the stabilizing process was made into two ratios of 0.90 and 1.00.

Furthermore, after this stabilized fiber was subjected to a pre-carbonization treatment by heating at 300 to 800° C. under an inert atmosphere, it was subjected to a carbonization treatment by heating under an inert atmosphere of the maximum temperature 1500° C. The draw ratios in the pre-carbonization treatment process were, for the fiber of its draw ratio in the stabilizing process was 0.90, 1.00 and, for that of 1.00, 1.10. The draw ratios in the carbonization treatment process were, for the fiber of its draw ratio in the stabilizing process was 0.90, 0.97 and, for that of 1.00, 1.00. Furthermore, the obtained carbonized fiber was subjected to an anode oxidation treatment in aqueous sulfuric solution at 10 coulomb/g-CF. The strength and single filament modulus of the obtained carbon fiber were measured and for the single filament modulus, its average value and its coefficient of variance were determined. The results are shown in Table 2.

However, the stabilized fiber yarns treated by the stabilization draw ratio 1.00 in Comparative examples 5 to 8 were impossible to be processed by the pre-carbonization draw ratio 1.10 due to fiber breakages, and stopped the production. Furthermore, the carbon fiber yarns of Comparative examples generated many fuzzes.

### Example 10

An oil agent was prepared in the same way as Example 7 except further adding a thermosensitive polymer. N-isopropyl acrylamide-based copolymer which was used in Example 3 as a thermosensitive polymer 0.5 parts by weight was added to 500 parts by weight of 25° C. water and stirred at 25° C. until dissolved, and then added to 400 parts by weight of the emulsified liquid of the same oil agent composition as Example 7 which is 30 wt % in pure component. The obtained oil agent was used by diluting with water to 2.0 wt % in pure component. A carbon fiber was obtained in the same way as Example 7 except changing the oil agent. The condition of draw ratio in stabilizing process 1.00, draw ratio in pre-carbonization process 1.10 and draw ratio in carbonization process 1.00 was adopted. As a result, as shown in Table 2, a good result was obtained such that the carbon fiber strength was 7.2 GPa and the coefficient of variance of single filament modulus was 7%.

### Example 11

An oil agent was prepared in the same way as Example 7 except further adding a liquid fine particle. An emulsified liquid SM8701EX (produced by Dow Corning Toray Co.) consisting of dimethyl silicone 10 parts by weight (kinematic viscosity at 150° C. is 180000 cSt), nonionic surfactant 2.3 parts by weight, water 26 parts by weight was added to 400 parts by weight of the same emulsified liquid as Example 7 which is 30 wt % in pure oil agent composition and stirred to obtain an oil agent. The hydrodynamical particle diameter of SM8701EX was 0.2 μm, as a result of measurement by a particle size distribution measuring instrument. In addition, the difference of osicillation period of pendulum between 30° C. and 200° C. measured by the free damped oscillation method of rigid-body pendulum was 0.02, the same difference of osicillation period of pendulum between 30° C. and 300° C. was 0.04. The obtained oil agent was used by diluting with water to 2.0 wt % in pure component. A carbon fiber was obtained in the same way as Example 10 except changing the oil agent. As a result, as show in Table 2, a good result was obtained such that the carbon fiber strength was 7.2 GPa and the coefficient of variance of single filament modulus was 7%.

### Example 12

An oil agent was prepared in the same way as Example 7 except further adding a thermosensitive polymer and a liquid fine particle. N-isopropyl acrylamide-based copolymer which was used in Example 3 as a thermosensitive polymer 0.5 parts by weight was added to 500 parts by weight of 25° C. water and stirred at 25° C. until dissolved, and then added to 400 parts by weight of the emulsified liquid of the same oil agent composition as Example 7 which is 30 wt % in pure component. Furthermore, an emulsified liquid SM8701EX (produced by Dow Corning Toray Co.) consisting of dimethyl silicone 10 parts by weight (kinematic viscosity at 150° C. is 180000 cSt), nonionic surfactant 2.3 parts by weight, water 26 parts by weight was added to obtain an oil agent. The obtained oil agent was used by diluting with water to 2.0 wt % in pure component. A carbon fiber was obtained in the same way as Example 10 except changing the oil agent. As a result, as shown in Table 2, a good result was obtained such that the carbon fiber strength was 7.3 GPa and the coefficient of variance of single filament modulus was 6%.

TABLE 1

| | Oil agent composition | | | | | | | |
|---|---|---|---|---|---|---|---|---|
| | | | Alicyclic | | Ethylene | | | Characteristics |
| | Amino-modified | | epoxy-modified | | oxide-modified | | | of oil agent |
| | silicone | | silicone | | silicone | | Average | Difference |
| | | parts | | parts | | parts | kinematic | of osicillation |
| | viscosity | by | viscosity | by | viscosity | by | viscosity | period |
| | (cSt) | weight | (cSt) | weight | (cSt) | weight | (cSt) | (sec) |
| Example 4 | 400 | 43 | 10000 | 5 | 150 | 52 | 750 | 0.10 |
| Example 5 | 1000 | 59 | 4500 | 7 | 300 | 34 | 1007 | 0.34 |
| Example 6 | 1000 | 67 | 3000 | 19 | 300 | 14 | 1282 | 0.11 |
| Example 7 | 1000 | 71 | 6000 | 8 | 300 | 21 | 1253 | 0.08 |
| Example 8 | 400 | 71 | 6000 | 8 | 300 | 21 | 827 | 0.07 |
| Example 9 | 1000 | 82 | 2000 | 3 | 300 | 15 | 925 | 0.38 |
| Comparative | 2000 | 66 | 10000 | 28 | 300 | 5 | 4135 | 0.15 |
| example 4 | | | | | | | | |
| Comparative | 5000 | 55 | 5000 | 40 | 300 | 5 | 4765 | 0.04 |
| example 5 | | | | | | | | |
| Comparative | 1000 | 40 | 6000 | 40 | 300 | 20 | 2860 | 0.02 |
| example 6 | | | | | | | | |
| Comparative | 1000 | 40 | 2000 | 40 | 300 | 20 | 1260 | 0.01 |
| example 7 | | | | | | | | |
| Comparative | 3500 | 100 | — | 0 | — | 0 | 3500 | 0.42 |
| example 8 | | | | | | | | |

TABLE 2

| | | | | | Average | |
|---|---|---|---|---|---|---|
| | | | | | value | coefficient |
| | | | | | of | of variance |
| | | | | Carbon | single | of single |
| | Draw ratio in | Draw ratio in | Draw ratio in | fiber | fiber | filament |
| | stabilization | pre-carbonization | carbonization | strength | modulus | modulus |
| | process | process | process | (GPa) | (GPa) | (%) |
| Example 4 | 0.90 | 1.00 | 0.97 | 6.2 | 309 | 8 |
| | 1.00 | 1.10 | 1.00 | 6.9 | 337 | 9 |
| Example 5 | 0.90 | 1.00 | 0.97 | 6.6 | 312 | 6 |
| | 1.00 | 1.10 | 1.00 | 7.1 | 340 | 8 |
| Example 6 | 0.90 | 1.00 | 0.97 | 6.2 | 313 | 6 |
| | 1.00 | 1.10 | 1.00 | 7.0 | 340 | 8 |
| Example 7 | 0.90 | 1.00 | 0.97 | 6.6 | 312 | 6 |
| | 1.00 | 1.10 | 1.00 | 7.1 | 340 | 8 |
| Example 8 | 0.90 | 1.00 | 0.97 | 6.6 | 313 | 5 |
| | 1.00 | 1.10 | 1.00 | 7.1 | 339 | 7 |
| Example 9 | 0.90 | 1.00 | 0.97 | 6.6 | 311 | 8 |
| | 1.00 | 1.10 | 1.00 | 6.8 | 339 | 9 |
| Comparative | 0.90 | 1.00 | 0.97 | 6.1 | 311 | 11 |
| example 4 | 1.00 | 1.10 | 1.00 | 7.1 | 337 | 11 |
| Comparative | 0.90 | 1.00 | 0.97 | 5.9 | 308 | 13 |
| example 5 | 1.00 | 1.10 | 1.00 | x | x | x |
| Comparative | 0.90 | 1.00 | 0.97 | 5.4 | 308 | 14 |
| example 6 | 1.00 | 1.10 | 1.00 | x | x | x |
| Comparative | 0.90 | 1.00 | 0.97 | 5.3 | 310 | 12 |
| example 7 | 1.00 | 1.10 | 1.00 | x | x | x |
| Comparative | 0.90 | 1.00 | 0.97 | 5.2 | 306 | 14 |
| example 8 | 1.00 | 1.10 | 1.00 | x | x | x |
| Example 10 | 1.00 | 1.10 | 1.00 | 7.2 | 340 | 7 |
| Example 11 | 1.00 | 1.10 | 1.00 | 7.2 | 340 | 7 |
| Example 12 | 1.00 | 1.10 | 1.00 | 7.3 | 340 | 6 |

### INDUSTRIAL APPLICABILITY

By using the oil agent for carbon fiber precursor of the present invention, it is possible to suppress an uneven stabilization at stabilizing process. As a result, even in case of a higher yarn density, higher tension, higher speed carbonization condition than conventional cases, it is possible to produce a carbon fiber having a stable quality without a fuzz or fiber breakage, and accordingly, it is possible to obtain a high quality and uniform quality carbon fiber. By using such a carbon fiber, it is possible to mold a composite material with a high performance and high reliability. Composite materials in which the carbon fiber obtained by the present invention is used can be preferably used for sports applications such as golf shaft or fishing rod, aerospace applications, applications for structural member of car such as a hood and propeller shaft and energy-related applications such as a fly wheel and CNG tank.

1. An oil agent for precursor fiber of carbon fiber containing a base compound and a liquid fine particle, and said liquid fine particle contains a liquid of which kinematic viscosity at 150° C. is 15000 cSt or more.

2. An oil agent for precursor fiber of carbon fiber according to claim 1, wherein said liquid is a silicone oil.

3. An oil agent for precursor fiber of carbon fiber according to claim 1, wherein a difference of osicillation period of pendulum of said liquid fine particle between 30° C. and 200° C., measured by the free damped oscillation method of rigid-body pendulum, is 0.1 second or less.

4. An oil agent for precursor fiber of carbon fiber according to claim 1, wherein a hydrodynamical particle diameter of said liquid fine particle is 0.05 to 5 μm.

5. An oil agent for precursor fiber of carbon fiber which contains a base compound and a thermosensitive polymer.

6. An oil agent for precursor fiber of carbon fiber according to claim 5, wherein said thermosensitive polymer is a polymer containing at least one monomer selected from N-isopropyl acrylamide and dimethyl aminoethyl methacrylate as a monomer component.

7. An oil agent for precursor fiber of carbon fiber containing a silicone compound of which average kinematic viscosity at 25° C. is 10 to 1500 cSt, and a difference of osicillation period of pendulum of said silicone compound between 30° C. and 180° C., measured by the free damped oscillation method of rigid-body pendulum, is 0.03 to 0.4 seconds.

8. An oil agent for precursor fiber of carbon fiber according to claim 7, which contains an amino-modified silicone, an alicyclic epoxy-modified silicone and an alkylene oxide-modified silicone, and a ratio of the alkylene oxide-modified silicone to the amino-modified silicone 100 parts by weight is 15 to 900 parts by weight and a ratio of an alicyclic epoxy-modified silicone to total silicone compound 100 parts by weight is 0 to 20 parts by weight.

9. A production method of carbon fiber containing at least a spinning process in which a polyacrylonitrile-based polymer is spun to obtain a precursor fiber of carbon fiber, a stabilizing process in which said precursor fiber is heated to 200 to 400° C. in oxygen-containing atmosphere to convert it into a stabilized fiber, and, a carbonization process in which said stabilized fiber is heated in an inert atmosphere of which temperature is at least 1000° C. to carbonize to convert it into a carbon fiber, wherein the oil agent for precursor fiber of carbon fiber according to claim 1 is imparted to the precursor fiber in said spinning process.

10. A carbon fiber of which coefficient of variance of single filament modulus determined by a single fiber tensile test is 10% or less.
